(19) United States
(12) Patent Application Publication
(10) Pub. No.: US 2026/0310561 A1
(43) Pub. Date: Oct. 8, 2026

(54) FAILURE PREDICTION AND SELF-HEALING CAPABILITIES IN HYPERSCALE PLATFORMS

(71) Applicant: Visa International Service Association, San Francisco, CA (US)

(72) Inventors: Xinrong Huang, Newark, CA (US); Durga S. Kala, Cupertino, CA (US); Gopalakrishnan Venkatasubramanian, San Jose, CA (US); Sowmya Mothekani, San Jose, CA (US); Manish Kumar Kaushik, Livermore, CA (US)

(73) Assignee: Visa International Service Association, San Francisco, CA (US)

(21) Appl. No.: 19/639,028

(22) Filed: Apr. 3, 2026

Related U.S. Application Data
(60) Provisional application No. 63/783,844, filed on Apr. 4, 2025.

(51) Int. Cl. G06F 11/20; G06F 11/07; G06F 11/34; G06N 5/04

(52) U.S. Cl. CPC G06F 11/203; G06F 11/0793; G06F 11/3409; G06N 5/04; G06F 2201/805; G06F 2201/81

(57) ABSTRACT

Embodiments provide self-healing capabilities within a hyperscale platform by leveraging an AI Agent Operating System (AIOS) control plane. Embodiments integrate a customizable rule engine that interacts seamlessly with the AIOS control plane features to effectively manage failures and faulty situations. The incorporation of generative AI, utilizing techniques such as Retrieval-Augmented Generation (RAG), optimizes failover paths and enhances system resilience by feeding operational data into customized Large Language Models (LLMs), thereby optimizing failover paths and enhancing system resilience. The system's adaptive nature ensures that the system continuously learns from operational data, dynamically adjusting its response mechanisms to maintain optimal performance

### CROSS-REFERENCES TO RELATED APPLICATIONS

This application claims the benefit of U.S. Provisional Application No. 63/783,844, filed on Apr. 4, 2025, which is herein incorporated by reference in its entirety for all purposes.

### BACKGROUND

In the evolving landscape of AI model platforms, ensuring high availability and reliability of applications is critical. Traditional systems often lack the resilience to recover from failures swiftly, leading to significant downtime and potential financial loss. They often depend on manual interventions, which are slow and prone to human error. Furthermore, these systems may not scale effectively across diverse infrastructure environments, leading to inconsistent performance and vulnerabilities. These systems often struggle to achieve stringent reliability standards. The challenge becomes even more pronounced when deploying applications on non-mainframe or open systems that are inherently less stable. The challenge is twofold: ensuring rapid recovery from failures while also predicting and mitigating potential issues before they impact the system.

Embodiments of the present invention solve these problems and other problems, individually and collectively.

### BRIEF SUMMARY

Embodiments provide self-healing capabilities within a hyperscale platform (a computing environment and architecture designed for extreme scalability, enabling the efficient handling of massive workloads and data processing) by leveraging an AI Agent Operating System (AIOS) control plane described herein. Embodiments integrate a customizable rule engine within a systems metrics analysis model that interacts seamlessly with the control plane features to effectively manage failures and faulty situations. The incorporation of Generative AI (GenAI), utilizing techniques such as Retrieval-Augmented Generation (RAG), optimizes failover paths and enhances system resilience by feeding operational data into customized Large Language Models (LLMs). The system's adaptive nature ensures that the system continuously learns from operational data, dynamically adjusting its response mechanisms to maintain optimal performance. Additionally, the AIOS control plane's integration with GenAI enables real-time analysis of metrics and trends, facilitating early detection of anomalies and potential failures. By automating the failover decision-making process and constantly refining the predefined rules, the system ensures high availability and reliability.

Various embodiments are directed to a method. The method comprises a monitoring system coupled to a processing system monitoring operation of the processing system, wherein the monitoring system includes an AI self-healing tool trained with past operation data of the processing system. The method further comprises generating a health signal representing one or more performance metrics associated with the operation of the processing system, analyzing the health signal using the AI self-healing tool, predicting an operational failure to potentially occur in a next predetermined amount of time based on an analysis of the health signal, determining a preventative action to prevent the operational failure from impacting the operation of the processing system, implementing the preventative action to keep the processing system operational, monitoring a reaction of the processing system to the preventative action; and re-training the AI self-healing tool with the reaction of the processing system to the preventative action.

Other embodiments provide a system comprising a monitoring system including an AI self-healing tool. The monitoring system may be coupled to a processing system. The monitoring system comprises one or more processors and a memory storing instructions that, when executed by the one or more processors, cause the one or more processors to perform the method described above.

These and other embodiments are described in further detail below.

### BRIEF DESCRIPTION OF THE DRAWINGS

FIG. 1 illustrates a diagram of an exemplary processing system according to various embodiments.

FIG. 2 illustrates a block diagram of an exemplary monitoring system comprising a system metrics analysis model and an AI self-healing tool according to embodiments.

FIG. 3 illustrates a self-healing processing system according to various embodiments.

FIG. 4 illustrates an exemplary architecture for a system metric analysis model according to embodiments.

FIG. 5 shows a flow diagram of a method of a self-healing processing system.

FIG. 6 illustrates an exemplary flow for a self-healing processing system.

FIG. 7 shows a block diagram of an example computer system usable with systems and methods, according to aspects of the disclosed technology.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “server computer” is typically a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processing system” may include a server computer used for interaction processing. In some embodiments, the processing system may be coupled to a database and may include any hardware, software, other logic, or combination of the preceding for servicing the requests from one or more client computers. The processing system may comprise one or more computational apparatuses and may use any of a variety of computing structures, arrangements, and compilations for servicing the requests from one or more client computers. In some embodiments, a processing system may include data processing subsystems, networks, and operations used to support and deliver authorization services, exception file services, and clearing and settlement services. An exemplary processing system may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The processing system may use any suitable wired or wireless network, including the Internet.

The processing system may process interaction-related messages (e.g., funds transfer related messages) and determine the appropriate destination computer (e.g., an authorizing entity computer) for the interaction-related messages. The processing system may also handle and/or facilitate the clearing and settlement of interactions.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

The term “artificial intelligence model” or “AI model” may refer to a model that may be used to predict outcomes in order to achieve a target goal. The AI model may be developed using a learning algorithm, in which training data is classified based on known or inferred patterns. An AI model may also be referred to as a “machine learning model.”

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines, models that classify data by establishing a gap or boundary between inputs of different classifications, as well as neural networks, collections of artificial “neurons” that perform functions by activating in response to inputs.

A “large language model” (LLM) can include a probabilistic model of a natural language. A large language model can generate probabilities of a series of words, based on text corpora in one or multiple languages it was trained on. Large language models can include a combination of feedforward neural networks and transformers. A large language model can include artificial neural networks that contain from tens of millions and up to billions of weights and can be (pre-)trained using self-supervised learning and semi-supervised learning. A large language model accept an input text and can repeatedly predict a next token or word as an output.

A “transformer” can include a deep learning architecture that utilizes attention mechanisms. A transformer can include primary components of 1) tokenizers, which convert text into tokens, 2) embedding layers, which convert tokens into semantically meaningful representations, and 3) transformer layers, which carry out the reasoning capabilities, and can consist of Attention and MLP layers. Transformer layers can be one of two types, encoder and decoder. A transformer can include an encoder, a decoder, or both an encoder and a decoder. Bidirectional encoder representations from transformers (BERT) are an example of encoder-only models, while generative pre-trained transformers (GPT) are an example of decoder-only models.

“Retrieval-Augmented Generation” or “RAG” is an advanced technique in artificial intelligence that combines the strengths of large language models (LLMs) with external information retrieval systems. In RAG, the AI integrates real-time access to databases, documents, or other knowledge sources to supplement its generative capabilities. Instead of relying solely on pre-trained data, RAG retrieves relevant information from external sources and uses it to produce more accurate, contextually relevant, and up-to-date responses. This approach is particularly useful for tasks requiring specific or dynamic knowledge, such as generating detailed reports, answering domain-specific questions, or providing fact-based content. By blending retrieval and generation, RAG enhances the AI's reliability and adaptability, making it a powerful tool for applications across industries.

A “health signal” may comprise a quantifiable metric or qualitative indicator used to describe the operational status, performance, or stability of a system, component, or process. In embodiments, a health signal may be derived from metrics or data sources, such as performance metrics, error rates, lag times, or resource utilization statistics. A health signal provides a proactive and predictive measurement of operational well-being. By utilizing a continuous view into system status, health signals enhance resilience and enable self-healing capabilities.

Traditional systems often lack the resilience to recover from failures swiftly, leading to significant downtime and potential financial loss. Embodiments provide a system that is self-healing (rapid recovery from failures) and that can predict and mitigate potential issues before they impact the system. Embodiments integrate a customizable rule engine that interacts seamlessly with control plane features to effectively manage failures and faulty situations. The incorporation of Generative AI (GenAI), including techniques like Retrieval-Augmented Generation (RAG), optimizes failover paths and enhances system resilience by feeding operational data into customized Large Language Models (LLMs). This system's adaptive nature ensures that it continuously learns from operational data, dynamically adjusting its response, thereby reducing downtime and failures.

Embodiments receive signals regarding the health of the different systems, implement machine learning to the input metrics to determine the health signals for the system, consult the rule engine to identify whether the system of an undesirable health signal requires remedial action, and implement self-healing actions (e.g., switch network traffic) based on the input metrics. The thresholds used to identify whether the input metric indicates a healthy or unhealthy system may be dynamically adjusted in view of the historical data. According to various embodiments, the input metrics are normalized and a RAG analysis is performed on the normalized input metrics. These steps help to identify the health state of the system based on historical data. When an unhealthy state is identified, the machine learning system identifies (and sometimes implements) remedial action in view of the historic data associated with similar failure(s).

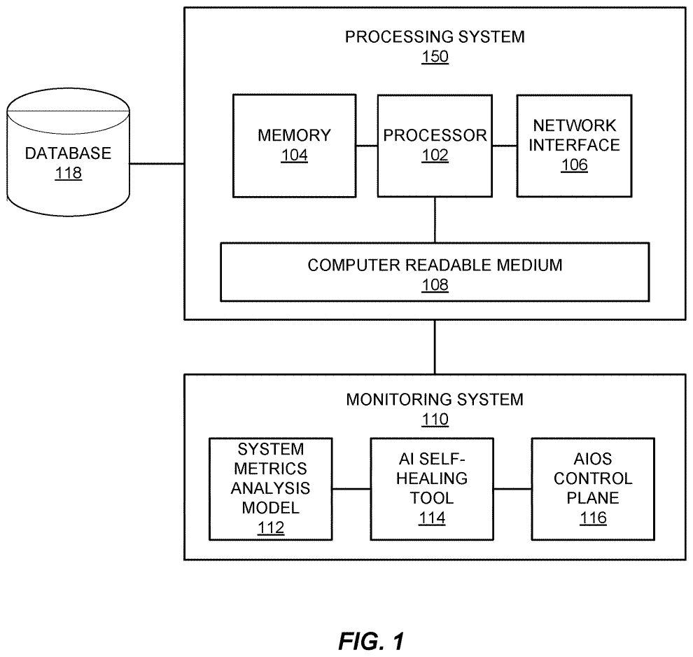

FIG. 1 shows a block diagram of the processing system 150 according to some embodiments of the invention. The processing system 150 may comprise a processor 102. The processor 102 may be coupled to a memory 104, a network interface 106, and a non-transitory computer readable medium 108. The processing system 150 may be in communication with a monitoring system 110, which may reside in the same processing system 150 or another computer. In some embodiments, the monitoring system 110 may comprise a system metrics analysis model 112, an AI self-healing tool 114, and an AIOS control plane 116. The monitoring system 110 may continuously monitor a processing system 150. While the processing system 150 is illustrated as a component outside of the monitoring system 110, one or more components of the processing system 150 may be provided within (e.g., as part of) the monitoring system 110, and vice versa. The processing system 150 may access a database 118. In some embodiments, the database 118 may be an integral part of the processing system 150.

In some embodiments, the processing system 150, or processing system can be spread across a cloud environment, wherein the monitoring system 110 is configured to operate across the cloud environment, and the preventative action is adapted according to cloud-specific infrastructure characteristics of the cloud environment.

The components in the system depicted in FIG. 1 can be in operative communication with each other through any suitable communication channel or communications network. Suitable communications networks may be any one and/or the combination of the following: a direct interconnection; a short-range communication protocol; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers, networks, and devices may be transmitted using secure communications protocols such as, but not limited to, Secure File Transfer Protocol (SFTP); Secure Hypertext Transfer Protocol (HTTPS), Secure Socket Layer (SSL), ISO (e.g., ISO 8583) and/or the like.

The computer readable medium 108 may comprise code, executable by the processor 102, to implement a method comprising: monitoring, by a monitoring system coupled to a processing system, operation of the processing system, wherein the monitoring system includes an AI self-healing tool trained with past operation data of the processing system; generating, by the monitoring system, health signal representing one or more performance metrics associated with the operation of the processing system; analyzing, by the monitoring system, the health signal using the AI self-healing tool; predicting, by the monitoring system, an operational failure to potentially occur in a next predetermined amount of time based on an analysis of the health signal; determining, by the monitoring system, a preventative action to prevent the operational failure from impacting the operation of the processing system; implementing, by the monitoring system on the processing system, the preventative action to keep the processing system operational; monitoring, by the monitoring system, reaction of the processing system to the preventative action; and re-training, by the monitoring system, the AI self-healing tool with the reaction of the processing system to the preventative action.

In some embodiments, the processing system 150 may be configured to utilize monitoring system 110 to monitor data from database 118. The systems metrics analysis model 112 can obtain metrics from the data from database 118 and analyze such metrics to determine the health of the system, thereby determining a health signal. The AI self-healing tool 112 may be connected to AIOS control plane 116 and work in conjunction to monitor components of the processing system 150 and determine health signals of components. In embodiments, the AIOS control plane 116 may comprise a rule engine that can aid in determining the health signal of the system. If the systems metrics analysis model 112 determines the health of the system to be less than a threshold, the AI self-healing tool 114 may determine the health signal and recommend actions to remediate the health of the system. If such actions are determined to be viable, the monitoring system may recommend and/or perform actions to processing system 150.

The memory 104 can be used to store data and code. The memory 104 may be coupled to the processor 102 internally or externally (e.g., cloud based data storage), and may comprise any combination of volatile and/or non-volatile memory, such as RAM, DRAM, ROM, flash, or any other suitable memory device.

The network interface 106 may include an interface that can allow the processing system 150 to communicate with external computers. Network interface 106 may enable the processing system 150 to communicate data to and from another device (e.g., transport computer, authorizing entity computer, etc.).

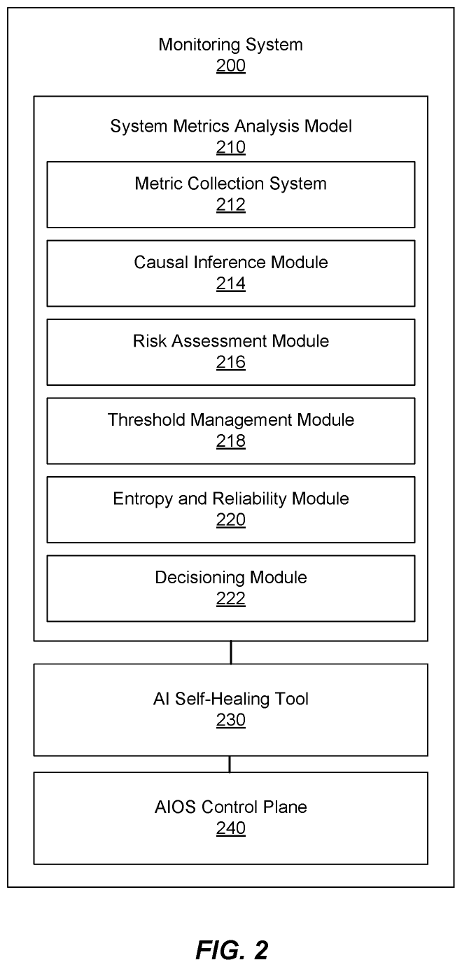

FIG. 2 depicts a monitoring system 200 comprising a system metrics analysis model 210, an AI self-healing tool 230, and an AIOS control plane 240. This monitoring system 200 is an exemplary embodiment of monitoring system 110 in FIG. 1.

The systems metrics analysis model 210 may comprise a metric collection system 212, a causal inference module 214, a risk assessment model 216, a threshold management module, an entropy and reliability module 220 and a decisioning module 222. The monitoring system 200 may receive data comprising raw metrics, which may be collected by the metric collection system 212. The raw metrics collected by the metric collection system 212 may include, for example, lag and service availability, throughput (requests/second), response time (latency), and resource utilization (CPU, memory, disk I/O), error rates, concurrency capacity, or network latency, server uptime among other performance metrics. The metric collection system 212 may process such metrics to normalize the metrics and/or perform other analysis or conversion to use the normalized metrics in the monitoring system. Normalizing raw metrics may help reduce bias in the monitoring system. The risk assessment model 216 can assign a weight to a normalized metric. The components of the systems metrics analysis model can enable a rule engine that hosts pre-defined rules and thresholds to help determine a health signal for a system.

The Metric Collection System 212 can collect metrics by monitoring the operations of a processing system. The metrics may come from the processing system or another database. Metrics may arrive in the form of a system state at an instant in time. Examples of metrics of the operations of a processing system include lag (e.g. Kafka lag which may be defined as the delay between the production and consumption of messages in Apache Kafka®), service health, system load, error rates and other characteristics of operations. This system can process the metrics to be suitable for further analysis. Analysis may include normalization and other relevant statistical or other analysis.

The monitoring system 200 may further comprise a causal inference module 214 configured to identify causal relationships among the performance metrics of the processing system and system events associated with the processing system, and wherein the preventative action is selected based on identified causality. The causal inference module 214 may employ statistical methods, structural models, or machine learning techniques to identify, estimate, and quantify the influence of specific factors or interventions on system outcomes. By distinguishing correlation from causation, the causal inference module enables the system to support more accurate predictions, optimize action and operations for the monitoring system.

The risk assessment model 216 can calculate an estimate risk of performing actions on metrics. For example, the risk assessment model 216 may produce a risk factor of changing a dynamic threshold. An example of a calculation the risk assessment model 216 might make is displayed below, showing the combination of each metrics multiplied by an assigned weight value, where wᵢ represents the weight metric i and mi represents the normalized value of metric i.

$$RiskScore = \sum ( {w}_{i} \times {m}_{i} )$$

The threshold management module 218 may dynamically adjust thresholds for metrics. The threshold management module 218 may analyze historical and/or real-time information to set or update threshold values for triggering actions, alerts, or state transitions within the system. Adjustments to thresholds may be performed using statistical analysis or other methods, enabling the module to adapt its criteria in response to changing conditions. The dynamic threshold module thereby enhances the system's ability to optimize performance, minimize false positives or negatives, and respond effectively to evolving operational contexts. Such thresholds may have initial value and dynamically adjust exemplary methods of computations the threshold management module 218 may perform is below.

$$NewThreshold = α \times CurrentValue + ( 1 - α ) \times OldThreshold$$

Where:
α=Learning rate (typically 0.15)

The Entropy and Reliability Module 220 may perform computations for entropy and reliability scores. This module may compute an entropy metric based on the distribution of information or semantic content among a plurality of metrics of operations. The entropy value may be used as an indicator of the degree of agreement or diversity, wherein a low entropy score corresponds to high consistency or redundancy in the metrics, and a high entropy score indicates substantial variation or disagreement. The system can utilize the computed entropy to determine reliability.

The entropy and reliability module 220 may determine a reliability score for an operation based on the calculate entropy. In one embodiment, the reliability score may be computed as 1 minus the ratio of the measured entropy to the logarithm of the number of retrieved items as shown below, such that lower entropy among the metrics yields a higher reliability value. This reliability score can be used to control subsequent processing steps, including the weighting of metrics provided to AI self-healing tool 230, or to trigger additional action when the score falls below a predetermined threshold. This module can also perform a performance optimization function, which may be subject to system constraints, resource limitations and performance thresholds.

$$Entropy = - \sum p ( x ) \times log ( p ( x ) )$$

$$ReliabilityScore = 1 - ( Entropy / log ( n ) )$$

$$SystemReliability = {Π ( 1 - {P}_{e , i} )}^{⋀} {w}_{i}$$

Where:
P_{e,i}=Error probability of component i
wᵢ=Component weight
p(x)=Probability of state x
n=Number of possible states

$$Performance Optimization Function = Maximize : E [ \sum {γ}^{t} \times R ( {S}_{t} , {D}_{t} ) ]$$

Where:
γ=Discount factor
R=Reward function
Sₜ=System state at time t
Dₜ=Decision at time t

The decisioning module 222 may take input from other modules to determine an action recommendation from AI self-healing tool 230. The decisioning module 222 is configured to receive and analyze one or more operational parameters or metrics associated with system components, processes, or external data sources. The decisioning module may evaluate these metrics against predetermined criteria, thresholds, or rules, and, based on the results of this evaluation, automatically determine whether to initiate, modify, or terminate one or more actions or operations within the system. Such actions may include, but are not limited to, adjusting resource allocations, invoking additional data retrieval or processing steps, triggering alerts or notifications, or modifying the behavior of downstream components. The decisioning module may thus function as an intelligent control mechanism, enabling dynamic and adaptive system responses to changing conditions or requirements.

The system metrics analysis model 210 may be connected to AI self-healing tool 230. While the AI self-healing tool 230 is illustrated as a component outside system metrics analysis model 210, one or more components of the AI self-healing tool 230 may be provided within (e.g., as part of) the system metrics analysis model 210, and vice versa. The AI self-healing tool 230 may be a machine learning model such as a large language model, which may utilize information from the processing system and the systems metrics analysis model 210 to recommend actions. The AI self-healing tool 230 may recommend actions based on available metrics, data, and historical data. If an action is performed, the AI self-healing tool can learn the result of such action and use the result to re-train the model to improve action recommendations.

The AI self-healing tool 230 may be connected to AIOS control plane 116, which continuously monitor the health of various components of the processing system and mark the health signal of components. The AI self-healing tool 230 may predict system failures in advance, and the AIOS control plane 116 can assign a health signal for components. For example, if the AI self-healing tool 230 predicts a failure of a component, the AIOS control plane 116 can mark the component as unhealthy.

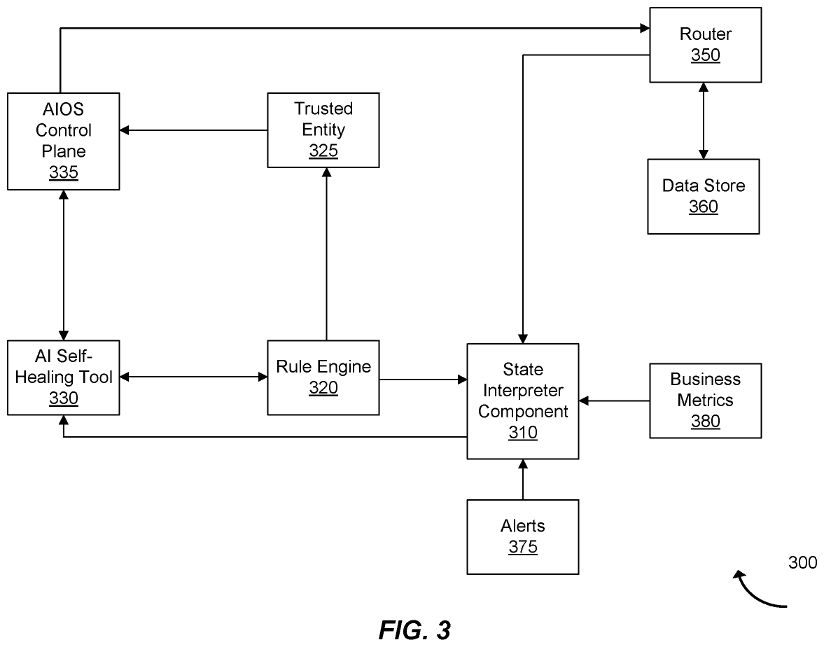

FIG. 3 illustrates a monitoring system according to various embodiments. The monitoring system 300 may be able to identify an operational failure to potentially occur in the near future (e.g., the next 30 seconds, minute, several minutes, hour(s)), identify and implement preventative action that keeps the processing system operational 99.9999% of the time. Accordingly, embodiments provide a system that has a self-healing capability as well as a future issue predicting capability, a system that is proactive rather than reactive.

According to various embodiments, the monitoring system 300 may generate a signal, e.g., a health signal, representing one or more metrics, e.g., performance metrics, associated with the operation of the processing system, analyze the health signal to predict the potential operational failure. For example, a health signal may be generated based on metrics and logs received from various components of the processing system, which may include elements such as router 350 and data store 360.

The state interpreter component 310 may retrieve information from a data store 360 (e.g., commercially available data store such as Redis), which may be configured to function as a database, a cache, and/or a message broker residing in a processing system or database. Data store 360 can support a variety of data structures, such as strings, hashes, lists, sets, and sorted sets. In certain implementations, data store 360 can be configured for data persistence by periodically saving the dataset to a durable storage medium. In some embodiments, the data store 360 may further comprise additional software tools to further optimize operations. An example of a software tool is Apache Kafka to capture, process and store streams of data in real-time. The data store 360 may provide data, such as the operations of a processing system and associated metrics, to a router 350 to route the data to a desired component.

A router 350, such as routing engine Routy, may be implemented in the monitoring system 300 to direct incoming network requests to the appropriate handler or endpoint within a software application. Router 350 can be configured to parse elements of a network request, such as a Uniform Resource Identifier (URI), and match patterns within the URI to a predefined set of routes. Each route can be associated with a specific function or controller responsible for processing the request and generating a response. The routing logic may support various request methods, parameter extraction, and the application of middleware. Router 350 may receive requests or actions from AIOS control plane 335 and route the actions to data store 360.

The state interpreter component 310 may also receive alerts 375, an alerting and notification framework for monitoring operational metrics and system events to detect and report anomalies or predefined conditions. Alerts 375 can be configured to ingest data from various sources, such as logs, performance counters, and application-specific metrics. A rule engine within the framework may continuously evaluate the incoming data against a set of configurable rules or thresholds. Upon the satisfaction of a rule's condition, the framework can generate an alert, which encapsulates information about the triggering event.

Business metrics are also transmitted to state interpreter component 310. The business metrics may originate from a processing system, database, or other data sources. These business metrics may comprise quantitative data points, such as operational statistics, that reflect performance or health of processing system, data base or general process. The state interpreter component 310 can use these ingested metrics to interpret the current state of the processing system.

The collected data (e.g., metrics, logs) from data store 360, business metrics 380, alerts 375 and router 350, is provided to a state interpreter component 310 that may interpret the current state of the system indicating whether the state is currently healthy, unhealthy, or degrading. This state may be used to determine a health signal for the system. Critical metrics that determine the health signal may be referred to as heartbeat metrics due to the vital information they convey about the system. In some embodiments, a messaging system may receive the collected data and transmit a message to state interpreter component 310. The collected data may be associated with a weight dependent on, for example, the source of the data. The state interpreter component 310 may ensure that the monitoring system 300 is aligned with standards of the system. The state interpreter component 310 can then provide this information to AI self-healing tool 330, including health signal information, to further analyze the collected data and understand the state for future failure protection.

The rule engine 320 can include a customizable set of rules for the collected data. The rule engine 320 allows the system to respond to faults in a dynamic manner, which means that recovery actions are tailored to specific fault conditions. This adaptability ensures that the system can swiftly address detected anomalies, minimize downtime and enhance resilience. The rule engine 320 benefits from real-time insights by integrating with the AI self-healing tool 330 and AIOS control plane 335 as it feeds rules and information to both, enabling the rule engine 320 to continuously adapt to evolving fault scenarios. This results in more precise and effective responses compared to traditional static systems. For example, if a component such as data store 360 is not functioning as expected, then the rule engine 320 may flag it as a critical condition. If the rule engine 320 determines that a component is in critical condition, the rule engine 320 may pass the metrics and analysis to an AI self-healing tool 330 to recommend actions to remedy the critical condition.

The rule engine may be in communication with trusted entity 325, which can trigger actions produced by the rule engine 320. A trusted entity may comprise any authorized user, business team, or computing system acting on behalf of an organization and authenticated according to predefined criteria. Such trusted entities are permitted to access, configure, or manage system resources consistent with assigned roles or privileges. A trusted entity 325 may perform production operations such as providing inputs to the AIOS control plane. The trusted entity may also define baseline thresholds and rules using their expertise and knowledge of the system that is being monitored. The rule engine may detect rules that are not followed by the current state, and thus may recommend an action to trusted entity 325, who can approve the action or recommend a different action. The trusted entity 325 helps train the monitoring system 300 to function optimally.

The AI self-healing tool 330 works in conjunction with the AIOS control plane 335 to enhance system resilience and reliability. The AIOS control plane 335 continuously monitors the health of various platform components, such as router 350, data store 360 and correlated components, by evaluating critical metrics including lag and service availability and using the health signal determined by the state interpreter component 310. These metrics may then be analyzed using a Large Language Model (LLM) for in-depth analysis. The LLM, e.g., an Anthropic model, equipped with Generative AI Retrieval-Augmented Generation (RAG) capabilities, compares the observed values against predefined rules and thresholds stored within the rule engine 320. When the monitored metrics exceed the set tolerance levels, the system assesses the necessity to make a change such as performing actions to maintain optimal performance. Leveraging Retrieval-Augmented Generation (RAG) methods allows real-time operational data to be fed into customized LLMs. These models continuously learn from ongoing operations, proposing the most efficient recovery strategies. This results in optimized failover paths, improved system integrity and reduced recovery times. The AI language model can deliver the identified changes back into the system, dynamically updating the thresholds and rules within the rule engine 320. This continuous learning and updating process ensures that the system adapts to changing conditions and maintains its robustness. In some embodiments, the AI self-healing tool can be further trained with one or more simulated failure scenarios generated via adversarial testing of the monitoring system to enhance a prediction accuracy for rare or novel operational failure conditions.

The AI self-healing tool 330 leverages its advanced learning capabilities to analyze different failure scenarios and the conditions that lead to these failures. By continuously updating its models based on this analysis, the AI self-healing tool 330 can predict potential failures before they occur and implement preventive measures. This tool can adapt to changing conditions in real-time, offering a significant advantage over prior static approaches. This proactive approach not only enhances the system's fault-tolerance but also ensures a more robust and resilient platform by minimizing downtime and maintaining high availability.

The AI self-healing tool 330 and AIOS control plane 335 work in harmony to provide a sophisticated self-healing mechanism that significantly boosts the reliability and efficiency of AI model platforms. This intricate design ensures that the ecosystem can meet the stringent uptime requirements and continue to operate smoothly, even in the face of unexpected challenges. The self-healing capabilities can integrate effortlessly with existing control plane features. This ensures a unified approach to managing system health, where various components are automatically coordinated to achieve optimal performance and reliability. For example, if the AI self-healing tool 330 and the AIOS control plane 335 determine a component is in critical condition and a certain action may remedy the condition, the AIOS control plane 335 may send an instruction for the certain action to router 350, which can implement such action.

The AI self-healing tool 330 as part of the monitoring system 300 can determine and implement a preventative action to prevent the operational failure from impacting the operation of the processing system. In some embodiments, the analysis of the health signal determined by the state interpreter component 310 can include identifying a threshold value for at least one of the one or more performance metrics, performing a rated risk analysis associated with the at least one of the one or more performance metrics; dynamically adjusting the threshold value based on the rated risk analysis; and comparing the health signal to dynamically adjusted threshold value to identify the operational failure. If the health signal (e.g., the at least one of the one or more performance metrics) is outside an acceptable range of the threshold, the monitoring system may identify the potential operational failure.

In some embodiments, the monitoring system 300 can determine the state of the processing system, and perform the preventative action if the state of the processing system is in a critical state. The monitoring system 300 can then verify if the processing system's state is back to normal, and learns from the implementation (e.g., state value, action taken, recovery occurred or not).

According to various embodiments, the monitoring system 300 may be trained with previous failure data that may not include remedial actions that were implemented manually. Therefore, when a potential operational failure is encountered for the first time, there may be a manual intervention. For example, the monitoring system may identify the potential operational failure, and one or more potential remedial actions. The monitoring system may then present the identified remedial actions to a user/controller, and wait for an input selecting one of the one or more potential remedial actions. The monitoring system may then learn from the experience and implement the learned behavior next time the potential operational failure is identified.

According to various embodiments, the monitoring system may apply risk assessment model and reliability model to the logs to determine why a critical state was caused. The risk assessment model and the reliability model identify the pre-checks or the pre-incidents that have caused a particular incident, a sequence of incidents or sequence of events that are observed in the logs or metrics. Then, the monitoring system may apply the analysis to the current system health data, predict a future critical state, and identify the remedial actions that prevent the critical state from occurring. The monitoring system may also calculate a risk score and entropy (e.g., as a measure of efficiency) for the actions, and apply the action based on associated risk score and entropy.

In an exemplary use case, the monitoring system is trained with data where a host in a cluster became offline and the cluster became no longer possible to be used due to certain activities. When the sequence of operations that lead to the host to become unavailable (or at least a portion the sequence of operations) is identified again, the monitoring system may take a preventative action to remove the host from the cluster before the failure happens. Preventive action may be identified based upon the events that the monitoring system is receiving. On the other hand, if the monitoring system has not seen the failure before (e.g., the system went down abruptly), where the monitoring system did not have a sequence of events that led up to the failure, the monitoring system may identify a healing or reactive action based on the prior training data (e.g., when host 1 is down, then prior action 1 brought it back up). The monitoring system may implement the healing or reactive action.

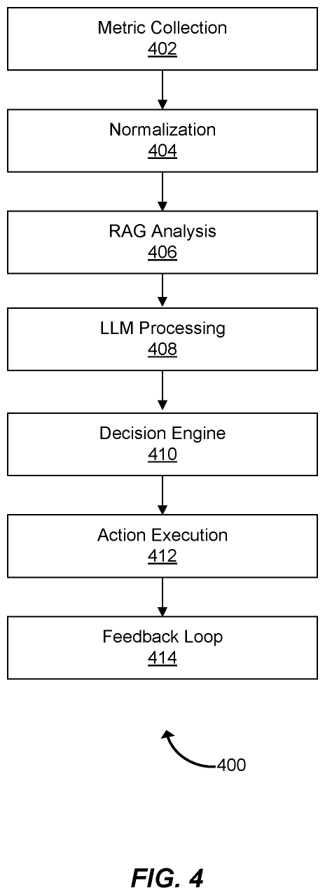

According to various embodiments, the monitoring system may perform a method 400 in FIG. 4 following actions prior to implementing a preventative action. A systems analysis model may begin with metric collection 402, where the model can collect one of the one or more performance metrics associated with the processing system. Metric collection 402 may include collecting metrics as well as processing such metrics. The monitoring system can process input metrics through a mathematical pipeline.

After metrics are collected, normalization 404 can normalize the collected metric data to reduce storage efficiency. Once the data is normalized the data, the entire source data does not need to be stored. For example, the metrics may be normalized by common statistical analysis such as the normalization formula below.

### Primary Metric Normalization:

$$Z = normalized metric score = ( M - μ ) / σ$$

Where:
M=Raw metric value
μ=Mean of historical metrics
σ=Standard deviation
Z=Normalized metric score

For example, a historical mean value for a metric may be 7 milliseconds with a standard deviation of 2 milliseconds. The normalized metric score calculated during normalization 404 can be 0.5, which can be implemented in further analysis.

The collected metrics can then be transmitted to the AI self-healing tool, which can perform RAG analysis 406 to perform RAG analysis on the normalized metric data. The RAG analysis process may involve retrieving a set of relevant data items from one or more data sources using search, indexing, or embedding-based retrieval methods. The retrieved content is then supplied as context to the AI self-healing tool, which synthesizes a recommendation that incorporates the retrieved information. The system may further analyze the coherence, coverage, or relevance of the retrieved and generated content, and may employ metrics to assess the quality of the analysis. An example of a RAG implementation that employs vector similarity calculations is provided below:

$$Similarity ( Q , D ) = cos ( Q , D ) = ( Q \cdot D ) / ( ‖ Q ‖ ‖ D ‖ )$$

Where:
Q=Query vector
D=Document vector
⋅=Dot product
∥x∥=Vector magnitude

After RAG analysis 406, the output can be processed by LLM processing 408 in the AI self-healing tool. The RAG analysis and the LLM processing may be performed separately or performed in parallel for a faster decision making process (e.g., computational power may be divided to process the RAG and LLM models). The LLM may process the metrics and RAG output if available to analyze the current situation of operations. If the LLM determines operations are in a critical state, the LLM may recommend no action, an action or no actions to relieve the critical state. The results of the LLM processing may be used to recommend actions to avoid operational issues. These results along with the RAG analysis results may be transmitted to the decision engine 410.

The Decision Engine 410 can then compare the outcome of the RAG analysis output and LLM processing output to a dynamic threshold value. The dynamic threshold value may be a value that is pre-defined for a metric and remedial action. In some embodiments, the decision engine 410 employs a Bayesian probability framework for decision making that calculates various probabilities of actions and metrics. For example, the decision engine 410 may calculate the following:

Bayesian probability framework for decision making:

$$P ( Action \vert Metrics ) = P ( Metrics \vert Action ) \times P ( Action ) / P ( Metrics )$$

Components:
   P(Action|Metrics)=Posterior probability
   P(Metrics|Action)=Likelihood
   P(Action)=Prior probability
   P(Metrics)=Evidence

After these probabilities are calculated, the decision engine 410 can compare these probabilities to the dynamic threshold value. In some embodiments, the probability of an action given the metrics exceeds the dynamic threshold value, the decision engine 410 can determine that the action should be taken. However, if the probability does not exceed the threshold value, the decision engine 410 can determine no action to be taken.

If the decision engine 410 determined a remedial action may be performed, the monitoring system can perform action execution 412. For example, if a software component of a datastore is unavailable and causing lag, the LLM processing 408 may recommend using an alternative software component to avoid this lag. The decision engine 410 can then compare the probability of using an alternative software component given the current lag to a dynamic threshold of lag. If the probability exceeds the threshold, then the action execution 412 can direct the monitoring system to use the alternative software component. Examples of actions may include marking system states as healthy or unhealthy, toggling system stacks, or diverting network traffic as part of the preventative action.

After actions are executed, the outcomes of the actions may be fed to feedback loop 414 to provide feedback to the AI self-healing tool and improve the tool. The monitoring system may maintain a dynamic threshold for certain amounts of time, and after feedback loop 414, train the system again. After a defined time period, the monitoring system may be able to learn that a threshold works without any warning.

Then, feedback loop 414 can provide this feedback, then update the threshold. The feedback loop can use risk scores to adjust thresholds as the model continues to train. One implementation of feedback loop integration entails the following:

FeedbackLoop(t) = f(CurrentState, PreviousDecisions, Outcomes)
SystemUpdate(t + 1) = g(CurrentState, FeedbackLoop(t))
Effectiveness = (SuccessfulActions/TotalActions) × 100%
ResponseTime = DetectionTime + ProcessingTime + ActionTime

The threshold can then be adjusted by equations similar to the following and abiding by operational constraints:

$${Threshold}_{t + 1} = {Threshold}_{t} + β \times ( ObservedValue - {Threshold}_{t} )$$

Where:
β=Adaptation rate
t=Time period
Operational constraints:
SystemLoad≤MaxCapacity
Response Time≤MaxLatency
ErrorRate≤MaxErrorThreshold

The monitoring system described herein is a learning tool that does not merely apply standard and static rules. The concepts of normalization, LLMs, and RAG analysis, and the feedback loops for decision making allow for the monitoring system to continuously learn from the implemented actions and improve.

The system incorporates continuous learning through historical data analysis, real-time metric processing, adaptive threshold management, and dynamic rule updates.

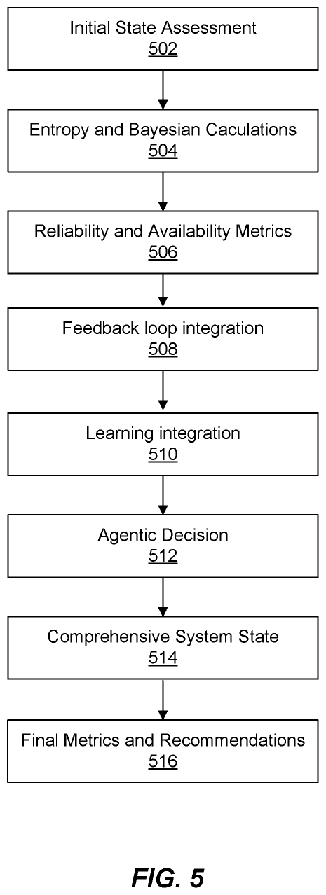

One embodiment of this disclosure is a data store switch failover analysis depicted in FIG. 5. The following example illustrates data store switch failover case scenario, where a data store may not function as expected and causes unusual lag. A data store switch failover may begin with an initial state assessment 502. In this example, based on the historical cases, the monitoring system calculates an initial state assessment including a base reliability. Metrics from the current state of the software components are retrieved and method 400 from FIG. 4 may be performed.

With the metrics from the initial state assessment 502, the entropy of the system is calculated by entropy and Bayesian calculations 504. First, an initial entropy can be calculated through an equation similar to the one below. The RAG analysis can be performed based upon the failure seen and the symptoms identified on the system. The RAG analysis can help understand the combination or possibilities for the failures based on the initial entropy. A second RAG knowledge entropy is then determined, followed by a combined entropy of the initial entropy and the RAD knowledge entropy.

Using these entropies, the monitoring system can calculate the probability of failure given the symptoms and the RAG analysis to understand the likelihood of failure.

```
Initial_Entropy = −Σ p(x) × log(p(x))
  = −(0.9 × log(0.9) + 0.08 × log(0.08) + 0.02 × log(0.02)) = 0.3745
RAG_Knowledge_Entropy = −Σ p(k) × log(p(k))
  = −(0.92 × log(0.92) + 0.08 × log(0.08)) = 0.2864
Combined_Entropy = (Initial_Entropy + RAG_Knowledge_Entropy)/2
  = 0.33045
P(Failure|Symptoms, RAG) = P(Symptoms|Failure) × P(Failure) ×
  RAG_Confidence
  = 0.95 × 0.1 × 0.92 = 0.0874
```

The monitoring system can also calculate a weighted entropy so if multiple actions can be performed, the monitoring system can provide a weighted entropy for each action that can be performed. When the monitoring system acts autonomously, the monitoring system will select and automatically implement the action with the highest weighted entropy and lower risk factor.

After entropy is calculated and Bayesian calculations are performed; the system may extract reliability and availability metrics 506 and further derive further metrics based on the extracted metrics. A reliability can be determined as a metric for the functionality and general reliability of the system in its current state. When the monitoring system is preloaded with logs for the monitoring system to train on, the monitoring system can calculate the reliability and availability scores for that particular system throughout the period that the monitoring system has trained for. These calculations provide a baseline reliability of the system using calculations such as:

```
RAG_Context = {“historical_cases”: 150, “relevant_matches”: 85,
  “context_confidence”: 0.92}
System_Reliability = {“redis_primary”: 0.99, “redis_secondary”: 0.99,
  “switch_mechanism”: 0.95, “network”: 0.98}
Total_System_Reliability = Π(System_Reliability) = 0.99 × 0.99 ×
  0.95 × 0.98 = 0.912 (91.2% BASELINE)
```

The monitoring system may retrieve availability metrics and perform further analysis to calculate an overall effective reliability. For example, the monitoring system may have the mean time to failure (MTTF) and mean time to recover (MTTR) based on what the monitoring system learned from monitoring the system over a period of time. These metrics can be used to calculate an availability metric. An effective reliability score can then be calculated using the total system reliability in combination with the availability metric. For example, a system may have a MTF of 720 hours and MTR of 0.5 hours, the subsequent metrics may be:

Availability = MTTF/(MTTF + MTTR = 720/(720 + 0.5) = 0.9993
(99.93%)
Reliability_Score = Total_System_Reliability × Availability = 0.912 ×
0.9993 = 0.911 (91.1% EFFECTIVE RELIABILITY)

After the system outputs recommendations, the monitoring system can utilize outputs and the metrics associated with outputs to perform feedback loop integration 508. The metrics associated with the output may include latency, error rate, and switch time. Each metric may also be associated with a threshold and/or a weight value that may be utilized in the feedback loop. In embodiments, the ratio can be combined in proportion to each current metric, e.g. current latency, to produce a threshold ratio. The monitoring system can then compute a feedback score by applying weight values to respective threshold ratio values associated with system measurements. The weighted results for each metric can be combined to produce a final feedback score. Below are an example of feedback metrics and an example calculation of a feedback score. During the feedback loop process, the system determines the current thresholds and the failure rates.

```
Feedback_Metrics = {
  “latency”: {“current”: 240ms, “threshold”: 30ms, “weight”: 0.4},
  “error_rate”: {“current”: 0.75, “threshold”: 0.01, “weight”: 0.3},
  “switch_time”: {“current”: 2s, “threshold”: 0.5s, “weight”: 0.3} }
```

$$\begin{matrix}Feedback\_Score = \sum ( metric\_weight \times ( threshold / current ) ) \\ = ( 0.4 \times 30 / 240 ) + ( 0.3 \times 0.01 / 0.75 ) + ( 0.3 \times 0.5 / 2 ) \\ = 0.129 ( CRITICAL )\end{matrix}$$

In this particular example, based upon the metric rates, the monitoring system identifies that the monitored system (e.g., the processing system) is in a critical state. The monitoring system will determine that the reliability is going to be impacted based upon the entropy rate and the reliability metrics.

After the action and feedback are implemented, the monitoring system can perform learning integration 510. The monitoring system can assimilate feedback and/or operational outcomes during this system to enable the model to continue learning from actions. An exemplary implementation includes a base learning rate, rag factor, entropy weight, and reliability factor. These metrics can be combined to obtain an enhanced learning rate which can be used to accelerate or decelerate learning. The monitoring system will then learn what happens after the action is performed, train on the outcome, and moving forward when a similar situation occurs, the monitoring system may automatically implement the corrective action. For example:

Base_Learning = 0.15
RAG_Factor = 0.92
Entropy_Weight = 1 − Combined_Entropy
Reliability_Factor = Total_System_Reliability
Enhanced_Learning_Rate = Base_Learning × RAG_Factor ×
Entropy_Weight ×
Reliability_Factor = 0.15 × 0.92 × 0.66955 × 0.912 = 0.0845

The monitoring system can then identify an agentic decision 512 (e.g., the monitoring system includes an agentic AI component) due to the entropy factor, the feedback score and the reliability getting impacted. If this is the first identified critical state scenario, the monitoring system may not know what action needs to be taken. The monitoring system may identify potential preventative or corrective actions by the agentic decision 512, and request user input to implement an action. Agentic decision parameters may include one or more of reliability, RAG confidence, an entropy factor and a feedback score. The monitoring system may also compute a combined decision score as a product of each decision parameter to obtain a decision point as the exemplary calculation below.

```
Decision_Parameters = {“reliability”: 0.911, “rag_confidence”: 0.92,
  “entropy_factor”: 0.66955, “feedback_score”: 0.129}
Combined_Decision_Score = Π(Decision_Parameters) = 0.911 × 0.92 ×
  0.66955 × 0.129 = 0.0716 (CRITICAL DECISION POINT)
```

The agentic decision can also consider characteristics with response metrics including a reliability response with confidence and urgency, a rag response with accuracy and relevance and a feedback response with certainty and stability. These metrics may be combined to obtain a final response score, which may identify whether an action should be recommended. For example, if a final response score is below threshold like the example below, an action may be highly recommended.

```
Response_Metrics = {
  “reliability_response”: {“confidence”: 0.911, “urgency”: 0.95},
  “rag_response”: {“accuracy”: 0.92,“relevance”: 0.88},
  “feedback_response”: {“certainty”: 0.129, “stability”: 0.78} }
Final_Response_Score = Π(Response_Metrics_Averages)
  = 0.93 × 0.90 × 0.45 = 0.377 (IMMEDIATE ACTION REQUIRED)
```

After the agentic decision, a comprehensive system state 514 can be determined. This system state entails all relevant information and metrics from the previous systems. An example of a comprehensive system state is below. This system state may include metrics such as entropy, reliability, feedback and learning rate, which may have been calculated in an earlier step. This system state also includes actions along with associated confidence, timing and monitoring. The system state also identifies action priority and can give a glimpse of the overall process of data store switch failover analysis. Using the exemplary metrics from before, a system state may be:

```
System_State = {
  “metrics”: {“entropy”: 0.33045, “reliability”: 0.911, “feedback”:
    0.129, “learning_rate”: 0.0845},
  “decisions”: {“primary_action”: “MANUAL_FAILOVER”,
    “confidence”: 0.377, “timing”: “IMMEDIATE”, “monitoring”:
    “CONTINUOUS”},
“learning”: {“rate”: 0.0845, reliability_factor”: 0.911,
“entropy_reduction”: 0.249} }
Action_Priority = {“level”: “P0_CRITICAL”, “confidence”: 0.377,
  “reliability_validated”: TRUE, “entropy_checked”: TRUE}
```

All final metrics and recommendations 516 may then be provided. These final metrics can include characteristics and metrics of the overall system as well as metrics from the analysis. The final analysis may include, for example, system health, reliability, learning, entropy and feedback values. System health is an example of a health signal, and provides an overview of the state of the current system. The recommendations may also be available, along with details such as the action, priority, monitoring, feedback interval and learning mode. Each of the metrics may be associated with a condition, such as critical, good, moderate, etc. An exemplary final analysis and recommendations is shown below.

```
Final_Analysis = {
  “system_health”: 0.377, # CRITICAL
  “reliability”: 0.911, # GOOD
  “learning”: 0.0845, # ACTIVE
  “entropy”: 0.33045, # MODERATE
  “feedback”: 0.129 # CRITICAL}
Recommendations = {
  “action”: “IMMEDIATE_MANUAL_FAILOVER”,
  “priority”: “P0”,
  “monitoring”: “CONTINUOUS”,
  “feedback_interval”: “100ms”,
  “learning_mode”: “ACTIVE”}
```

Once the monitoring system performs a particular action, the monitoring system can recalculate whether the monitored system has reached the expected state. If the availability and reliability factors have not met, and the monitored system is still not desirable, the monitoring system can update its learning that the implemented action is not be the corrective action for the identified system failure/problem. An integrated analysis may show for example:

Critical system health (0.377)
Good baseline reliability (0.911)
Active learning rate (0.0845)
Moderate entropy (0.33045)
Critical feedback score (0.129)
Action Required = IMMEDIATE_MANUAL_INTERVENTION
Monitoring_Level = CONTINUOUS
Learning_Status = ACTIVE
Reliability_Status = MONITORED
Feedback_Loop = CRITICAL_ACTIVE

In addition to providing recommendations, embodiments may implement one of the recommendations automatically. In some embodiments, an agent may perform the recommended action to minimize operational issues in minimal time. Whether the action should be taken can be determined based on a combination of system metrics such as reliability and accuracy.

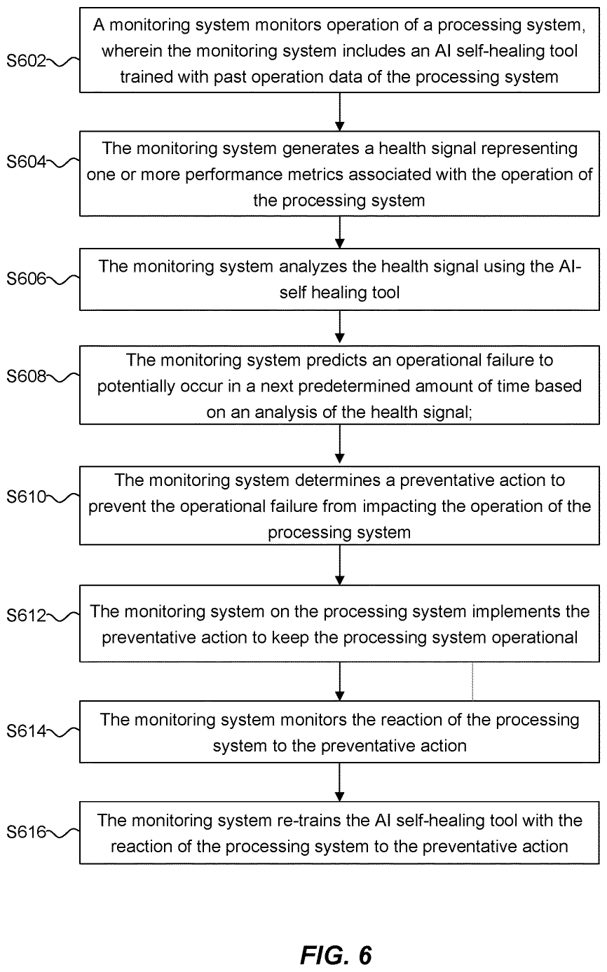

An exemplary method of a self-healing capabilities within a hyperscale platform is shown in FIG. 6 as a flow chart. This method may allow systems to swiftly return to typical functioning with minimal friction, thereby avoiding manual intervention and allows metrics like lag to be minimized in real-time, as well as prevented in the future.

At step S602, a monitoring system coupled to a processing system can monitor operation of the processing system, wherein the monitoring system includes an AI self-healing tool trained with past operation data of the processing system. For example, the monitoring system may be monitoring lag for operations of the processing system. The monitoring system may have an initial system configuration with a base threshold (T₀) of 10 milliseconds, a confidence level (C) of 95%, and a learning rate (α) of 0.15. The monitoring system may continuously monitor metrics such as lag, service health, system load and error rate.

The monitoring system may retrieve historical contexts to determine a health signal. In some embodiments, this may be done by identifying a threshold value associated with health signals such as the example below. Health signals in this example include a performance metric of lag and associated outcomes, such as service degradation, performance warning and normal operation. The historical metrics may be compared with the current metric to determine the similarity of the current state to historical data to better understand the severity of the current state. Similarity calculations are employed by RAG analysis. The monitoring system can use the similarity scores to aid in determining an overall health signal.

```
Historical_Vector = [
    {lag: 12 ms, outcome: “service_degradation”},
    {lag: 9 ms, outcome: “performance_warning”},
    {lag: 7 ms, outcome: “normal_operation”} ]
Similarity Calculation
  Similarity_Score = cos(Current_Vector, Historical_Vector)
  Similarity_Score = 0.85
```

Based on the similarity scores that it has allocated from the historical vector and the current vector retrieved from RAG and LLM analysis, the monitoring system calculates the new threshold to be 9.7 milliseconds. Since the current value was determined to be 8 milliseconds, the system can be considered stable in this example. However, the current value is closer to the dynamically adjusted score of 9.7 milliseconds, and therefore the monitoring system can recommend proactive monitoring.

Some embodiments may also perform a rated risk analysis associated with the at least one of the one or more performance metrics and dynamically adjust the threshold value based on the rated risk analysis. The monitoring system may also compare the performance metric to dynamically adjusted threshold value to identify the operational failure. Examples of calculating risk scores and dynamic thresholds are below.

```
T₁ = α × Current_Value + (1−α) × Initial_Threshold
T₁ = 0.15 × 8 + 0.85 × 10
T₁ = 9.7ms
Risk_Weights = {
  w₁: 0.4 (lag)
  w₂: 0.3 (trend)
  w₃: 0.3 (volatility) }
Risk_Score = Σ(wᵢ × factorᵢ)
Risk_Score = 0.71
```

At step S604, the monitoring system can generate a health signal representing one or more performance metrics associated with the operation of the processing system. Using the normalized performance metrics and thresholds, the monitoring system can generate a health signal, such as an alert. For example, the monitoring system may run logic such as below to generate an alert. The dynamic threshold may also be updated.

```
IF (current_lag > dynamic_threshold) OR (risk_score > 0.7)
THEN
  Generate_Alert( )
  Update_Threshold( )
```

At step S606, the monitoring system can analyze the health signal using the AI self-healing tool. The AI self-healing tool may be a large language model that can interpret the health signal and associated data. For example, the AI self-healing tool can interpret the alert and other health signals (e.g. performance metrics), such as lag, together. After interpreting this, the large language model may suggest actions to remedy issues identified in the processing system caused by operations that did not meet a preferable health signal.

At step S608, the monitoring system can predict an operational failure to potentially occur in a next predetermined amount of time based on an analysis of the health signal. The monitoring system may predict an operational failure due to a poor health signal; thus the monitoring system may recommend actions to be taken swiftly.

At step S610, the monitoring system can determine a preventative action to prevent the operational failure from impacting the operation of the processing system. The preventative action may be chosen based on identified causality of the operational failure. An example system log of a lag with a poor health signal is below including an action recommendation to initiate proactive monitoring in order to remedy the lag issue.

“timestamp”: “2024-01-20T10:15:00Z”,
“metric_type”: “lag”,
“current_value”: “8ms”,
“dynamic_threshold”: “9.7ms”,
“risk_score”: “0.71”,
“alert_status”: “WARNING”,
“action_recommendation”: “Initiate proactive monitoring.”

At step S612, the monitoring system on the processing system can implement the preventative action to keep the processing system operational. In some embodiments, the processing system may include a primary processing path and a failover path, wherein the preventative action implemented by the monitoring system on the processing system includes switching processing from the primary processing path to the failover path at least for a predetermined period of time.

At step S614, the monitoring system can monitor the reaction of the processing system to the preventative action. For example, the monitoring system can store previous outcomes alongside metrics of such outcomes, e.g. accuracy rate, false positive rate and response time. These metrics can be used to log the outcome of actions and help predict future outcomes.

Previous_Outcomes = {
accuracy_rate: 67%,
false_positive_rate: 33%,
response_time: 1.2s }

In the aforementioned exemplary implementation, the system achieved: 67% detection accuracy, 33% reduction in false positives, 1.2 second average response time and 95% confidence level in alerts. This implementation illustrates that all the metrics that are associated with the processing system are collected. Initially the base threshold is identified based upon the rule engine defining, in this example, that the threshold is 10 milliseconds and the current lag is 8 milliseconds. A lag that is greater than 10 milliseconds indicate an unhealthy system, and anything below 10 milliseconds is normal state.

At step S616, the monitoring system can re-train the AI self-healing tool with the reaction of the processing system to the preventative action. Embodiments may further comprise the monitoring system using the AI self-healing tool identifying an alternative failure scenario unrelated to the health signal that can cause the operational failure based on historical data. The monitoring system may then implement mitigating measures that prevent the alternative failure scenario from occurring. An alternative failure scenario may entail, for example, a different component causing issues in the system due to an action from the monitoring system.

According to various embodiments, even though the monitoring system calculated a new dynamic threshold, it will not directly go back and apply that threshold to the system. Instead, the monitoring system will perform a weighted risk analysis to identify the risk associated with changing (e.g., updating) the current threshold to the newly identified dynamic threshold. If the monitoring system associates the risk and the risk weight associated with the new threshold is going to be lower, then the monitoring system may update the existing threshold to the newly identified dynamic threshold. For example, the monitoring system may test the newly identified dynamic threshold for a predetermined amount of time prior to changing the existing threshold to the newly identified dynamic threshold.

According to various embodiments, the monitoring system can also take actions as it autonomously makes agentic decisions and updates rules based on learned patterns and feedback. In some embodiments, the actions may be executed by an agent. The monitoring system interfaces with the AI control plane to trigger actions such as marking systems healthy or unhealthy, turning stacks on or off, and diverting traffic. This decision-making capability allows the monitoring system to operate independently and enhance its rules based on real-time data and risk assessments. According to various embodiments, the first actions performed by the monitoring system may be mostly manual or pre-defined actions to prevent the monitoring system to take an action without learning that performing an operation has actually brought down the processing system to a normal state.

Embodiments autonomously manage and distribute workloads based on current conditions, improving computing speeds and data processing efficiency.

These features collectively bring several improvements to computing technology including (1) Improved Computing Speeds: The system's ability to dynamically manage and recover from faults ensures that applications remain performant, reducing latency and enhancing user experience; (2) Enhanced Security: By swiftly addressing faults and anomalies, the system reduces vulnerabilities and potential attack vectors, thereby enhancing overall cybersecurity; (3) Optimized Data Storage: The adaptability of the rule engine and AI models ensures that data is stored and retrieved efficiently, minimizing redundancy and maximizing storage utilization; (4) Increased Bandwidth Efficiency: By optimizing failover paths and recovery strategies, the system ensures that network resources are used effectively, preventing bottlenecks and improving data throughput; (5) Novel Data Structures: The integration of RAG techniques introduces novel ways of structuring and retrieving operational data, which enhances the system's ability to learn and adapt in real-time.

Overall, embodiments set a new benchmark in self-healing technologies, providing substantial improvements in reliability, efficiency, and security, and ensuring that the ecosystem (e.g., transaction processing network ecosystem) can continue to operate smoothly and efficiently, even under challenging conditions.

The implementation of this self-healing capability brings substantial business value by significantly improving productivity and reliability within the ecosystem. The key benefits include:

The reduction in downtime and automated recovery processes streamline operations, enhance productivity, allowing teams to focus on innovation and strategic tasks rather than firefighting issues.

Achieving 99.9999% of uptime ensures that applications remain available and performant, even in the face of unexpected failures. This heightened reliability is crucial for maintaining customer trust and ensuring seamless transaction processing.

By leveraging advanced AI technologies and integrating them with AIOS control plane, embodiments enhance the overall stability and security of the system's infrastructure.

Embodiments not only address the critical need for high reliability and availability in Hyperscale platform but also sets a new standard for self-healing technologies in the financial ecosystem. By fostering a resilient and adaptable system, it ensures that the ecosystem can continue to operate smoothly and efficiently, even under challenging conditions.

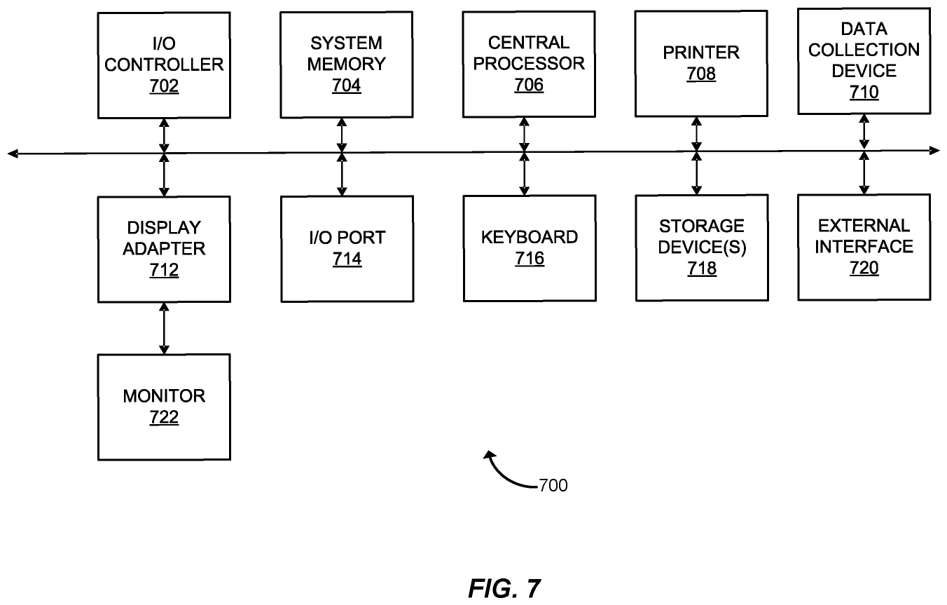

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 724. Additional subsystems such as a printer 708, keyboard 716, storage device(s) 718, monitor 722 (e.g., a display screen, such as an LED), which is coupled to display adapter 712, and others are shown. Peripherals and input/output (I/O) devices, which couple to I/O controller 702, can be connected to the computer system by any number of means known in the art such as input/output (I/O) port 714 (e.g., USB, FireWire®). For example, I/O port 714 or external interface 720 (e.g., Ethernet, Wi-Fi, etc.) can be used to connect computer system 700 to a wide area network such as the Internet, a mouse input device, or a scanner. The interconnection via system bus 724 allows the central processor 706 to communicate with each subsystem and to control the execution of a plurality of instructions from system memory 704 or the storage device(s) 718 (e.g., a fixed disk, such as a hard drive, or optical disk), as well as the exchange of information between subsystems. The system memory 704 and/or the storage device(s) 718 may embody a computer readable medium. Another subsystem is a data collection device 710, such as a camera, microphone, accelerometer, and the like. Any of the data mentioned herein can be output from one component to another component and/or can be output to a user.

A computer system can include a plurality of the same components or subsystems, e.g., connected together by external interface 720, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 10, 200, 500, 1,000, 10,000, 50,000, 100,000, 500,000, or one million communication messages. Such communications can involve at least 1 MB, 10 MB, 100 MB, 1 GB, 10 GB, or 100 GB of data.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be measured in millisecond(s), second(s), 1 minute, 1 hour, or 1 day. Thus, embodiments involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all portions of a step may be optional. Additionally, and of the steps of any of the methods can be performed with modules, circuits, or other means for performing these steps.

The specific details of particular embodiments may be combined in any suitable manner without departing from the spirit and scope of embodiments of the disclosure. However, other embodiments of the disclosure may involve specific embodiments relating to each individual aspect, or specific combinations of these individual aspects. The above description of exemplary embodiments of the disclosure has been presented for the purpose of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary. The use of “or” is intended to mean an “inclusive or,” and not an “exclusive or” unless specifically indicated to the contrary.

What is claimed is:

1. A method comprising:
monitoring, by a monitoring system coupled to a processing system, operation of the processing system, wherein the monitoring system includes an AI self-healing tool trained with past operation data of the processing system;
generating, by the monitoring system, health signal representing one or more performance metrics associated with the operation of the processing system;
analyzing, by the monitoring system, the health signal using the AI self-healing tool;
predicting, by the monitoring system, an operational failure to potentially occur in a next predetermined amount of time based on an analysis of the health signal;
determining, by the monitoring system, a preventative action to prevent the operational failure from impacting the operation of the processing system;
implementing, by the monitoring system on the processing system, the preventative action to keep the processing system operational;
monitoring, by the monitoring system, reaction of the processing system to the preventative action; and
re-training, by the monitoring system, the AI self-healing tool with the reaction of the processing system to the preventative action.

2. The method of claim 1, wherein implementing the preventative action keeps the processing system operational 99.9999% of the time.

3. The method of claim 1, wherein analyzing the health signal comprises:
identifying a threshold value for at least one of the one or more performance metrics;
performing a rated risk analysis associated with the at least one of the one or more performance metrics;
dynamically adjusting the threshold value based on the rated risk analysis; and
comparing the health signal to dynamically adjusted threshold value to identify the operational failure.

4. The method of claim 1, wherein the processing system includes a primary processing path and a failover path, wherein the preventative action implemented by the monitoring system on the processing system includes switching processing from the primary processing path to the failover path at least for a predetermined period of time.

5. The method of claim 1, further comprising:
identifying, by the monitoring system using the AI self-healing tool, an alternative failure scenario unrelated to the health signal that can cause the operational failure based on historical data; and
implementing, by the monitoring system, mitigating measures that prevent the alternative failure scenario from occurring.

6. The method of claim 1, wherein the preventative action is identified in a rule engine that matches recovery actions with fault conditions including operational failures, wherein the rule engine is updated continuously in real time.

7. The method of claim 6, further comprising:
identifying, by the monitoring system, a potential operational failure for which no remedial action is stored in the rule engine;
presenting, by the monitoring system, one or more candidate remedial actions to a user;
receiving, by the monitoring system, a user input selecting a remedial action;
implementing, by the monitoring system, the remedial action; and
updating, by the monitoring system, the AI self-healing tool to autonomously implement the remedial action in future scenarios similar to the potential operational failure.

8. The method of claim 1, wherein the AI self-healing tool includes an large language model (LLM) module and a retrieval-augmented generation (RAG) module, and is trained using real time operational data.

9. The method of claim 1, further comprising:
prior to predicting an operational failure:
comparing, by the monitoring system using the AI self-healing tool, a current state vector of the processing system to a historical events vector associated with the processing system to identify a deviation from normal operation for the processing system;
determining, by the monitoring system, a probability for at least one scenario associated with the deviation from the normal operation; and
selecting, by the monitoring system, the preventative action based on the probability of the at least one scenario being higher than a threshold value.

10. The method of claim 9, further comprising:
continuously adjusting, by the monitoring system, the threshold value in view of monitoring the processing system over time.

11. The method of claim 1, wherein the monitoring system comprises a causal inference module configured to identify causal relationships among the performance metrics of the processing system and system events associated with the processing system, and wherein the preventative action is selected based on identified causality.

12. The method of claim 1, wherein the AI self-healing tool is further trained with one or more simulated failure scenarios generated via adversarial testing of the monitoring system to enhance a prediction accuracy for rare or novel operational failure conditions.

13. The method of claim 1, further comprising:
calculating, by the monitoring system, a risk score and an entropy value for each potential preventative action; and
selecting, by the monitoring system, the preventative action with lowest associated risk and highest weighted entropy.

14. A system comprising:
a monitoring system comprising an AI self-healing tool, the monitoring system coupled to a processing system, the monitoring system comprising one or more processors and a memory storing instructions that, when executed by the one or more processors, cause the one or more processors to perform steps comprising:
monitoring operation of the processing system, wherein the AI self-healing tool is trained with past operation data of the processing system;
generating health signal representing one or more performance metrics associated with the operation of the processing system;
analyzing the health signal using the AI self-healing tool;
predicting an operational failure to potentially occur in a next predetermined amount of time based on an analysis of the health signal;
determining a preventative action to prevent the operational failure from impacting the operation of the processing system;
implementing, on the processing system, the preventative action to keep the processing system operational;
monitoring reaction of the processing system to the preventative action; and
re-training the AI self-healing tool with the reaction of the processing system to the preventative action.

15. The system of claim 14, further comprising:
a rule engine that matches recovery actions with fault conditions including operational failures, wherein the rule engine is updated continuously in real time, wherein the preventative action is identified in the rule engine,
wherein the instructions, when executed on the one or more processors, further cause the one or more processors to perform steps comprising:
identifying a potential operational failure for which no remedial action is stored in the rule engine;
presenting one or more candidate remedial actions to a user;
receiving a user input selecting a remedial action;
implementing the remedial action; and
updating the AI self-healing tool to autonomously implement the remedial action in future scenarios similar to the potential operational failure.

16. The system of claim 14, wherein the AI self-healing tool includes an large language model (LLM) module and a retrieval-augmented generation (RAG) module, and is trained using real time operational data.

17. The system of claim 14, wherein the instructions, when executed on the one or more processors, further cause the one or more processors to perform steps comprising:
prior to predicting an operational failure:
comparing, using the AI self-healing tool, a current state vector of the processing system to a historical events vector associated with the processing system to identify a deviation from normal operation for the processing system;
determining a probability for at least one scenario associated with the deviation from the normal operation; and
selecting the preventative action based on the probability of the at least one scenario being higher than a threshold value.

18. The system of claim 14, wherein the monitoring system further comprises a causal inference module configured to identify causal relationships among the performance metrics of the processing system and system events associated with the processing system, and wherein the preventative action is selected based on identified causality.

19. The system of claim 14, wherein the processing system is spread across a cloud environment, wherein the monitoring system is configured to operate across the cloud environment, and the preventative action is adapted according to cloud-specific infrastructure characteristics of the cloud environment.

20. The system of claim 14, further comprising:
the processing system comprising a control plane, wherein the monitoring system interfaces with the control plane of the processing system to autonomously execute actions including one or more of marking system states as healthy or unhealthy, toggling system stacks, or diverting network traffic as part of the preventative action.
